(19) United States
(12) Patent Application Publication
(10) Pub. No.: US 2018/0332879 A1
(43) Pub. Date: Nov. 22, 2018

(54) AGENT FOR IMPROVING AFTERTASTE HAVING HIGH INTENSITY SWEETENERS

(71) Applicant: NAGAOKA CO., LTD., Osaka (JP)

(72) Inventors: Seiji HASHIMOTO, Ibaraki-shi (JP); Kimihiro HIGASHI, Tokyo (JP); Syunsuke YOSHINAGA, Tokyo (JP); Tatsunori TAKIMOTO, Tokyo (JP); Jyunji TOBARI, Tokyo (JP); Nozomu HIRATA, Osaka-shi (JP); Hirokazu KANENO, Osaka-shi (JP)

(73) Assignee: Nagaoka Co., Ltd., Osaka (JP)

(21) Appl. No.: 15/983,852

(22) Filed: May 18, 2018

(30) Foreign Application Priority Data
May 18, 2017 (JP) 2017098704

(51) Int. Cl. A23L 27/00; A23L 27/30

(52) U.S. Cl. CPC A23L 27/84; A23L 27/88; A23L 27/32; A23V 2002/00; A23L 27/37; A23L 27/36; A23L 27/30

(57) ABSTRACT

A improving agent for improving aftertaste having high-intensity sweeteners according to the present disclosure contains isobutyl angelate as an active ingredient. A method for improving a sweet taste according to the present disclosure includes adding 0.001 to 1 ppm of isobutyl angelate to an oral composition containing a high-intensity sweetener.

### BACKGROUND OF THE INVENTION

### 1. Technical Field

The present disclosure relates to an improving agent for improving aftertaste having high-intensity sweeteners, an oral composition having an improved sweet taste, and a method for improving the sweet taste of an oral composition.

### 2. Background

The basic tastes experienced upon the intake of foods, beverages and the like include a sweet taste, a sour taste, a salty taste, a bitter taste and an umami taste. The flavor of a food or beverage is brought about by a combination of these five tastes.

In recent years, high-intensity sweeteners have been used widely as sweetener components. High-intensity sweeteners are lower in calories compared with the conventional sweeteners such as sucrose, glucose and fructose, and the degrees of sweetness of high-intensity sweeteners are several tens to several thousands times greater than the degree of sweetness of sucrose. High-intensity sweeteners are excellent sweeteners from the viewpoint of the pathogenesis of lifestyle diseases, including obesity and diabetes, associated with the excessive intake of sugars such as sucrose. When a high-intensity sweetener is taken, however, unnatural sweetness is often sensed as an aftertaste. A method for improving an unpleasant aftertaste of a high-intensity sweetener is reported (see, for example, Japanese Unexamined Patent Publication No. 2011-24428 and Japanese Unexamined Patent Publication No. 2011-30535). Japanese Unexamined Patent Publication No. 2011-24428 discloses an improving agent for improving taste having high-intensity sweeteners, which contains Davana oil. Japanese Unexamined Patent Publication No. 2011-30535 discloses an improving agent for improving taste having high-intensity sweeteners, which contains a ginger extract.

However, the improving agents disclosed in Japanese Unexamined Patent Publication No. 2011-24428 and Japanese Unexamined Patent Publication No. 2011-30535 may alter the influence of a food or beverage itself by the action of Davana oil and a ginger extract contained therein. Therefore, the improving agents disclosed in Japanese Unexamined Patent Publication No. 2011-24428 and Japanese Unexamined Patent Publication No. 2011-30535 may deteriorate the flavor of a food or beverage itself, even though the unpleasant aftertaste of the high-intensity sweetener can be improved.

### SUMMARY

The problem of the present disclosure is to provide a improving agent for improving aftertaste having high-intensity sweeteners, which, when added to an oral composition such as a food or beverage and an oral hygiene product, can improve the unpleasant aftertaste and the impure taste (e.g., a harsh taste, an astringent taste) of a high-intensity sweetener contained in the oral composition without deteriorating a flavor intrinsic to the oral composition.

An improving agent for improving aftertaste having high-intensity sweeteners according to the present disclosure contains isobutyl angelate as an active ingredient. An oral composition having an improved sweet taste according to the present disclosure includes an oral composition containing a high-intensity sweetener and the improving agent, wherein the improving agent is contained in an amount of 0.001 to 1 ppm in terms of an isobutyl angelate content. A method for improving the sweet taste of an oral composition containing a high-intensity sweetener according to the present disclosure includes adding 0.001 to 1 ppm of isobutyl angelate to the oral composition.

According to the present disclosure, it becomes possible to provide an improving agent for improving aftertaste having high-intensity sweeteners, which, when added to an oral composition such as a food or beverage and an oral hygiene product, can improve the unpleasant aftertaste and the impure taste (e.g., a harsh taste, an astringent taste) of a high-intensity sweetener contained in the oral composition without deteriorating a flavor intrinsic to the oral composition. According to the present disclosure, it also becomes possible to provide an oral composition (e.g., a food or beverage, an oral hygiene product) having an improved sweet taste, in which the unpleasant aftertaste and the impure taste (e.g., a harsh taste, an astringent taste) of a high-intensity sweetener contained in the oral composition is improved without deteriorating a flavor intrinsic to the oral composition.

### DETAILED DESCRIPTION

A improving agent for improving aftertaste having high-intensity sweeteners (also simply referred to as a “improving agent”, hereinafter) according to one embodiment of the present disclosure contains isobutyl angelate as an active ingredient. Isobutyl angelate is one of angelates and has a structure represented by formula (I).

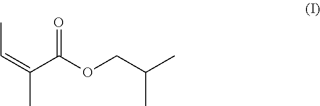

Isobutyl angelate is a compound obtained by esterifying (isobutyl-esterifying) angelic acid ((Z)-2-methyl-2-butenoic acid) represented by formula (II).

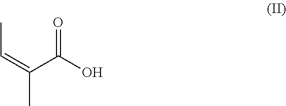

Isobutyl angelate may be a chemically synthesized product or a product derived from a natural material. Isobutyl angelate derived from a natural material is preferably one derived from Roman chamomile (Anthemis nobilis). Roman chamomile is a perennial plant belonging to the family Asteraceae. In an essential oil or an extract of Roman chamomile, isobutyl angelate, butyl angelate, isopropyl angelate and the like are contained as the main components.

An essential oil of Roman chamomile can be obtained by subjecting Roman chamomile to steam distillation, squeezing or the like. The part of Roman chamomile to be used is not limited. All parts including petals, leaves and stems can be used, and petals are preferably used.

An extract of Roman chamomile can be produced by subjecting Roman chamomile to reflux extraction, normal temperature homogenization extraction, supercritical fluid extraction or the like. The part of Roman chamomile to be used is not limited. As in the case with the essential oil, all parts including petals, leaves and stems can be used, and petals are preferably used. In the case where Roman chamomile is extracted with a solvent like a reflux extraction method, specific examples of the solvent include: an organic solvent such as alcohols (e.g., a lower alcohol such as methanol and ethanol, or a polyhydric alcohol such as ethylene glycol, propylene glycol, 1,3-butylene glycol and glycerin), a glycerin fatty acid ester, ketones having a relatively high polarity (e.g., acetone) and esters (e.g., ethyl acetate); and water.

Each of the essential oil and the extract of Roman chamomile contains an angelic acid ester such as isobutyl angelate, and therefore can be used without any modification as the isobutyl angelate. Alternatively, the essential oil or the extract of Roman chamomile may be purified to remove impurities therefrom, or isobutyl angelate may be isolated from the essential oil or the extract of Roman chamomile for practical use.

The improving agent according to one embodiment of the present disclosure may contain other components, as long as the advantageous effect of the present invention cannot be impaired. The form of the improving agent according to one embodiment of the present disclosure is not particularly limited. For example, the improving agent may be prepared in the form of a liquid preparation or a powdery preparation.

In the case where the improving agent is used in the form of a liquid preparation, isobutyl angelate may be diluted with a solvent, for example. Specific examples of the solvent to be used for the dilution include water, ethanol, glycerin, propylene glycol, triacetin, a medium-chain triglyceride, and an animal or vegetable oil or fat.

Alternatively, the improving agent may be combined with an auxiliary component or other active ingredient to prepare a mix. For example, the improving agent may be used in combination with any one of known various natural fragrances, synthetic fragrances and the like.

The improving agent according to one embodiment of the present disclosure may be mixed with an excipient (e.g., dextrin, gum arabic, lactose) and the above-mentioned solvent, and then a resultant mixture may be spray-dried to prepare a powdery or granular preparation or may be lyophilized or heat-dried to prepare a solid preparation. The improving agent according to one embodiment of the present disclosure may be prepared into various forms depending on the intended uses thereof.

The high-intensity sweetener of which an unpleasant aftertaste and the impure taste (e.g., a harsh taste, an astringent taste) can be improved by the improving agent according to one embodiment of the present disclosure is not particularly limited. The term “high-intensity sweetener” refers to a sweetener having a degree of sweetness of several tens to several thousands of times larger than that of sucrose. Specific examples of the high-intensity sweetener include aspartame, acesulfame potassium, saccharin, saccharin sodium, sucralose, stevia, glycyrrhizin, dipotassium glycyrrhizinate, phyllodulcin, thaumatin, neotame and alitame. These high-intensity sweeteners may be added to a food or beverage singly, or a combination of two or more of them may be added to a food or beverage.

In addition to the above-mentioned compounds, the high-intensity sweetener may also be an extract containing any one of these compounds. Examples of the extract include a glycyrrhiza extract, a stevia extract, a monk fruit (Siraitia grosvenorii) extract, and an amacha (hydrangea leaves) extract.

The improving agent according to one embodiment of the present disclosure is added to an oral composition containing a high-intensity sweetener in practical use. The amount of the improving agent to be added is set appropriately depending on the type or amount of the high-intensity sweetener contained in the oral composition. The improving agent is generally added so as to be contained in the oral composition in an amount of about 0.001 to 1 ppm by mass, preferably about 0.005 to 0.5 ppm by mass, in terms of isobutyl angelate content. Specific examples of the oral composition include a food or beverage, an oral hygiene product, and a medicine.

The food or beverage containing the high-intensity sweetener is not particularly limited, as long as the food or beverage contains a high-intensity sweetener. Specific examples of the food or beverage include: a soft drink such as a fruit beverage, a vegetable beverage, a sports supplement drink, a cocoa beverage, coffee, a coffee beverage, and a black tea beverage; a health food such as a drinkable preparation suitable for nutritional supplement purposes, and a nutritional functional food; an alcoholic beverage such as wine, a spirit-based beverage, and a canned shochu-based beverage; a non-alcoholic beverage such as a beverage having a beer-like taste, a beverage having a shochu-based beverage-like taste, a beverage having a spirit-based beverage-like taste, and a beverage having a wine-like taste; sweet stuffs such as jelly, pudding, ice cream, chocolate, candy, chewing gum, cake, castella (a Japanese sponge cake), cream puff, doughnut, cookies, snack, manju (a Japanese steamed bread), dango (a Japanese rice dumpling), monaka (a Japanese wafer filled with red bean jam) and yokan (a Japanese red bean jelly); and a dairy product such as coffee-flavored milk, tea with milk, milk with a green tea powder, fruit-flavored milk, yoghurt and a lactic acid bacteria beverage.

The oral hygiene product containing a high-intensity sweetener is not particularly limited, as long as the oral hygiene product contains the high-intensity sweetener. Specific examples of the oral hygiene product include a tooth paste, a mouth wash and an oral wash.

When the improving agent according to one embodiment of the present disclosure is added to the above-mentioned oral composition containing a high-intensity sweetener, it becomes possible to produce a sweet-taste-improved oral composition which is improved in the unpleasant aftertaste or the impure taste (e.g., a harsh taste, an astringent taste) of a high-intensity sweetener contained in the oral composition without deteriorating a flavor intrinsic to the oral composition. The improving agent according to one embodiment of the present disclosure can be used suitably in the fields of food industries, medical/quasi drug industries.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Japanese application No. 2017-098704, filed May 18, 2017, are incorporated by reference herein.

### EXAMPLES

Hereinbelow, the improving agent according to the present disclosure will be specifically described with reference to examples and comparative examples. However, the improving agent according to the present disclosure is not intended to be limited by these examples.

### Preparation Example 1

First, 0.03 g of Isobutyl angelate was diluted with hydrous ethanol (ethanol concentration: 60% by mass) so that the total amount became 1000 g. The concentration of isobutyl angelate in the resultant solution was 30 ppm by mass.

### Preparation Example 2

First, 0.1 g of Roman chamomile essential oil was diluted with hydrous ethanol (ethanol concentration: 60% by mass) so that the total amount became 1000 g. Angelates contained in Roman chamomile essential oil used were shown below. In Roman chamomile essential oil, 32.9% by mass of the angelates were contained. The concentration of the a angelates in the resultant solution was about 33 ppm by mass.

Propyl angelate: 2.9% by mass

Isobutyl angelate: 28.5% by mass

2-Methyl-2-butyl angelate: 1.5% by mass

Butyl angelate: a trace amount

tert-Butyl angelate: a trace amount

### Preparation Example 3: Preparation of Sweetener Solutions

Solutions, each having a sweetness degree corresponding to an 8% by mass aqueous sugar solution, were prepared using the various high-intensity sweeteners shown in Table 1. In Table 1, each of the sweetness degrees represents the intensity of sweetness wherein the sweetness degree of sugar is defined as 1, and each of the concentrations represents the concentration of a high-intensity sweetener in the solution.

TABLE 1

| | | Sweetness | | |
|---|---|---|---|---|
| | | degree | Concentration | |
| Solution | Sweetener | (times) | (% toy mass) | Characteristics of sweetener |
| | Sugar | 1 | 8 | The sweetness was elegant. The |
| | | | | sweetness was soft and rich. |
| | | | | The sweetness was also mild and |
| | | | | did not remain on the tongue. |
| Solution | Aspartame | 200 | 0.04 | The way of rising sweetness was |
| 1 | (L-phenylalanine | | | close to that of sugar. The |
| | compound) | | | sweetness lasted for a longer |
| | | | | period than sugar, and remained |
| | | | | on the tongue. |
| Solution | Acesulfame | 200 | 0.04 | The sweetness was cool unlike |
| 2 | potassium | | | sugar. The sweetness remained |
| | | | | as an aftertaste on the tongue |
| | | | | for a prolonged period. |
| Solution | Sucralose | 600 | 0.0135 | The quality of the sweetness was |
| 3 | | | | close to sugar, but was not rich |
| | | | | unlike sugar. The sweetness |
| | | | | remained as an aftertaste on the |
| | | | | tongue for a prolonged period. |
| Solution | Stevia extract | 360 | 0.022 | The sweetness rose slowly. The |
| 4 | | | | sweetness remained as an |
| | | | | aftertaste, and the crispness of |
| | | | | the sweetness was worst. The |
| | | | | sweetness was not elegant. At |
| | | | | the last stags, a bitter taste |
| | | | | and an astringent taste were |
| | | | | sensed. |
| Solution | Acesulfame | 200 | 0.028 | The quality of the sweetness was |
| 5 | potassium + | | | close to sugar, but the |
| | sucralose | 600 | 0.004 | sweetness remained as an |
| | | | | aftertaste on the tongue for a |
| | | | | prolonged period. |
| Solution | Acesulfame | 200 | 0.028 | The sweetness remained as an |
| 6 | potassium + | | | aftertaste, and a harsh taste |
| | stevia extract | 400 | 0.006 | and an astringent taste were |
| | | | | sensed. |
| Solution | Acesulfame | 200 | 0.02 | The quality of the sweetness was |
| 7 | potassium + | | | close to sugar, but the |
| | aspartame | 200 | 0.02 | sweetness remained as an |
| | | | | aftertaste on the tongue for a |
| | | | | prolonged period. |

### Example 1: Improvement of Taste of Aspartame

The resultant solution 1 (an aspartame solution) in Preparation Example 3 was added the resultant solution in Preparation Example 1 in an amount of 0.033% by mass. The concentration of isobutyl angelate added to the solution 1 was 0.0099 ppm by mass. The taste of the solution 1 having isobutyl angelate added thereto was evaluated by the following method. The result is shown in Table 2.

The solution 1 (without addition of isobutyl angelate) was tasted by seven panelists (one twenty-something male, one thirty-something male, one forty-something male, one fifty-something male, one sixty-something male, and one twenty-something female and one thirty-something female). Subsequently, the seven panelists rinsed their mouths sufficiently, and then the solution 1 containing isobutyl angelate (with addition of isobutyl angelate) was tasted by the seven panelists. The panelists compared the isobutyl-angelate-free solution with the isobutyl-angelate-added solution, and then determined whether or not the quality of sweetness and the impure taste of the isobutyl-angelate-added solution were improved compared with the isobutyl-angelate-free solution in accordance with the following criteria. When the sum total of the scores determined by the seven panelists was 10 points or greater, it was determined that the quality of sweetness and the impure taste were improved.

2 points: the quality of sweetness and the impure taste were remarkably improved;

1 point: the quality of sweetness and the impure taste were improved; and

0 point: the quality of sweetness and the impure taste were not improved.

### Example 2: Improvement of Taste of Aspartame

The resultant solution 1 in Preparation Example 3 was added the resultant solution in Preparation Example 2 in an amount of 0.033% by mass. The concentration of the angelates added to the solution 1 was about 0.0109 ppm by mass. Comparison was made between the solution 1 (without addition of the angelates) and the solution 1 containing the angelates (with addition of the angelates), and the evaluation was carried out in the same manner as in Example 1. The result is shown in Table 2.

### Example 3: Improvement of Taste of Acesulfame Potassium

The resultant solution 2 (an acesulfame potassium solution) in Preparation Example 3 was added the resultant solution in Preparation Example 1 in an amount of 0.033% by mass. The concentration of isobutyl angelate added to the solution 2 was about 0.0099 ppm by mass. Comparison was made between the solution 2 (without addition of isobutyl angelate) and the solution 2 containing isobutyl angelate (with addition of isobutyl angelate), and the evaluation was carried out in the same manner as in Example 1. The result is shown in Table 2.

### Example 4: Improvement of Taste of Acesulfame Potassium

The resultant solution 2 in Preparation Example 3 was added the resultant solution in Preparation Example 2 in an amount of 0.033% by mass. The concentration of the angelate esters added to the solution 2 was about 0.0109 ppm by mass. Comparison was made between the solution 2 (without addition of the angelates) and the solution 2 containing the angelates (with addition of the angelates), and the evaluation was carried out in the same manner as in Example 1. The result is shown in Table 2.

### Example 5: Improvement of Taste of Sucralose

The resultant solution 3 (a sucralose solution) in Preparation Example 3 was added the resultant solution in Preparation Example 1 in an amount of 0.1% by mass. The concentration of isobutyl angelate added to the solution 3 was about 0.03 ppm by mass. Comparison was made between the solution 3 (without addition of isobutyl angelate) and the solution 3 containing isobutyl angelate (with addition of isobutyl angelate), and the evaluation was carried out in the same manner as in Example 1. The result is shown in Table 2.

### Example 6: Improvement of Taste of Sucralose

The resultant solution 3 in Preparation Example 3 was added the resultant solution in Preparation Example 2 in an amount of 0.1% by mass. The concentration of the angelates added to the solution 3 was about 0.033 ppm by mass. Comparison was made between the solution 3 (without addition of the angelates) and the solution 3 containing the angelates (with addition of the angelates), and the evaluation was carried out in the same manner as in Example 1. The result is shown in Table 2.

### Example 7: Improvement of Taste of Stevia Extract

The resultant solution 4 (a stevia extract solution) in Preparation Example 3 was added the resultant solution in Preparation Example 1 in an amount of 0.125% by mass. The concentration of isobutyl angelate added to the solution 4 was about 0.0375 ppm by mass. Comparison was made between the solution 4 (without addition of isobutyl angelate) and the solution 4 containing isobutyl angelate (with addition of isobutyl angelate), and the evaluation was carried out in the same manner as in Example 1. The result is shown in Table 2.

### Example 8: Improvement of Taste of Stevia Extract

The resultant solution 4 in Preparation Example 3 was added the resultant solution in Preparation Example 2 in an amount of 0.125% by mass. The concentration of the angelates added to the solution 4 was about 0.0413 ppm by mass. Comparison was made between the solution 4 (without addition of the angelates) and the solution 4 containing the angelates (with addition of the angelates), and the evaluation was carried out in the same manner as in Example 1. The result is shown in Table 2.

### Example 9: Improvement of Taste of Mixture of Acesulfame Potassium and Sucralose

The resultant solution 5 (a mixed solution of acesulfame potassium and sucralose) in Preparation Example 3 was added the resultant solution in Preparation Example 1 in an amount of 0.125% by mass. The concentration of isobutyl angelate added to the solution 5 was about 0.0375 ppm by mass. Comparison was made between the solution 5 (without addition of isobutyl angelate) and the solution 5 containing isobutyl angelate (with addition of isobutyl angelate), and the evaluation was carried out in the same manner as in Example 1. The result is shown in Table 2.

### Example 10: Improvement of Taste of Mixture of Acesulfame Potassium and Sucralose

The resultant solution 5 in Preparation Example 3 was added the resultant solution in Preparation Example 2 in an amount of 0.125% by mass. The concentration of the angelates added to the solution 5 was about 0.0413 ppm by mass. Comparison was made between the solution 5 (without addition of the angelates) and the solution 5 containing the angelates (with addition of the angelates), and the evaluation was carried out in the same manner as in Example 1. The result is shown in Table 2.

### Example 11: Improvement of Taste of Mixture of Acesulfame Potassium and Stevia Extract

The resultant solution 6 (a mixed solution of acesulfame potassium and stevia extract) in Preparation Example 3 was added the resultant solution in Preparation Example 1 in an amount of 0.1% by mass. The concentration of isobutyl angelate added to the solution 6 was about 0.03 ppm by mass. Comparison was made between the solution 6 (without addition of isobutyl angelate) and the solution 6 containing isobutyl angelate (with addition of isobutyl angelate), and the evaluation was carried out in the same manner as in Example 1. The result is shown in Table 2.

### Example 12: Improvement of Taste of Mixture of Acesulfame Potassium and Stevia Extract

The resultant solution 6 in Preparation Example 3 was added the resultant solution in Preparation Example 2 in an amount of 0.1% by mass. The concentration of the angelates added to the solution 6 was about 0.033 ppm by mass. Comparison was made between the solution 6 (without addition of the angelates) and the solution 6 containing the angelates (with addition of the angelates), and the evaluation was carried out in the same manner as in Example 1. The result is shown in Table 2.

### Example 13: Improvement of Taste of Mixture of Acesulfame Potassium and Aspartame

The resultant solution 7 (a mixed solution of acesulfame potassium and aspartame) in Preparation Example 3 was added the resultant solution in Preparation Example 1 in an amount of 0.125% by mass. The concentration of isobutyl angelate added to the solution 7 was 0.0375 ppm by mass. Comparison was made between the solution 7 (without addition of isobutyl angelate) and the solution 7 containing isobutyl angelate (with addition of isobutyl angelate), and the evaluation was carried out in the same manner as in Example 1. The result is shown in Table 2.

### Example 14: Improvement of Taste of Mixture of Acesulfame Potassium and Aspartame

The resultant solution 7 in Preparation Example 3 was added the resultant solution in Preparation Example 2 in an amount of 0.125% by mass. The concentration of the angelates added to the solution 7 was about 0.0413 ppm by mass. Comparison was made between the solution 7 (without addition of the angelates) and the solution 7 containing the angelates (with addition of the angelates), and the evaluation was carried out in the same manner as in Example 1. The result is shown in Table 2.

TABLE 2

| | | Improving agent | | |
|---|---|---|---|---|
| | Solution | (% by mass) | Evaluation | |
| Example | Solution | Preparation Example 1 (0.033) | 14 | The sweetness did not |
| 1 | 1 | (0.0099 ppm by mass) | points | last, and did not remain |
| Example | | Preparation Example 2 (0.033) | 14 | on the tongue. The |
| 2 | | (about 0.0109 ppm by mass) | points | taste was improved. |
| Example | Solution | Preparation Example 1 (0.033) | 14 | The sweetness did not |
| 3 | 2 | (0.0099 ppm by mass) | points | remain as an aftertaste |
| Example | | Preparation Example 2 (0.033) | 14 | and did not remain on |
| 4 | | (about 0.0109 ppm by mass) | points | the tongue. The taste |
| | | | | was improved. |
| Example | Solution | Preparation Example 1 (0.1) | 14 | The sweetness did not |
| 5 | 3 | (0.03 ppm by mass) | points | remain as an aftertaste |
| Example | | Preparation Example 2 (0.1) | 14 | and did not remain on |
| 6 | | (about 0.033 ppm by mass) | points | the tongue. The taste |
| | | | | was improved. |
| Example | Solution | Preparation Example 1 (0.125) | 13 | The sweetness did not |
| 7 | 4 | (0.0375 ppm by mass) | points | remain as an aftertaste, |
| Example | | Preparation Example 2 (0.125) | 14 | and a bitter taste and |
| 8 | | (about 0.0413 ppm by mass) | points | an astringent taste was |
| | | | | not sensed. The taste |
| | | | | was improved. |
| Example | Solution | Preparation Example 1 (0.125) | 14 | The sweetness did not |
| 9 | 5 | (0.0375 ppm by mass) | points | remain as an aftertaste |
| Example | | Preparation Example 2 (0.125) | 14 | and did not remain on |
| 10 | | (about 0.0413 ppm by mass) | points | the tongue. The taste |
| | | | | was improved. |
| Example | Solution | Preparation Example 1 (0.1) | 13 | The sweetness did not |
| 11 | 6 | (0.03 ppm by mass) | points | remain as an aftertaste, |
| Example | | Preparation Example 2 (0.1) | 13 | and a harsh taste and an |
| 12 | | (about 0.033 ppm by mass) | points | astringent taste was not |
| | | | | sensed. The taste was |
| | | | | improved. |
| Example | Solution | Preparation Example 1 (0.125) | 14 | The sweetness did not |
| 13 | 7 | (0.0375 ppm by mass) | points | remain as an aftertaste |
| Example | | Preparation Example 2 (0.125) | 14 | and did not remain on |
| 14 | | (about 0.0413 ppm by mass) | points | the tongue. The taste |
| | | | | was improved. |

The concentration of each of the improving agent shown in the lower column represents a concentration of isobutyl angelate or the angelates.

As shown in Table 2, it is obviously demonstrated that the unpleasant aftertaste and the impure taste (e.g., a harsh taste, an astringent taste) of a high-intensity sweetener contained in a solution can be improved by adding isobutyl angelate or Roman chamomile essential oil containing isobutyl angelate to the solution.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. An improving agent for improving aftertaste having high-intensity sweeteners comprising: isobutyl angelate as an active ingredient, and at least one solvent or excipient selected from the group consisting of ethanol, hydrous ethanol, glycerin, hydrous glycerin, propylene glycol, hydrous propylene glycol, vegetable oil, medium-chain triglyceride, triacetin dextrin and gum arabic.

2. The improving agent according to claim 1, wherein the isobutyl angelate is an ester derived from Roman chamomile (Anthemis nobilis).

3. An oral composition having an improved sweet taste, comprising:
an oral composition containing a high-intensity sweetener; and
the improving agent according to claim 1,
wherein the improving agent is contained in an amount of 0.001 to 1 ppm in terms of an isobutyl angelate content.

4. The oral composition having an improved sweet taste according to claim 3, wherein the oral composition is a food or beverage or an oral hygiene product.

5. A method for improving the sweet taste of an oral composition containing a high-intensity sweetener, the method comprising adding 0.001 to 1 ppm of isobutyl angelate to the oral composition.

6. The method according to claim 5, wherein the isobutyl angelate is an ester derived from Roman chamomile (Anthemis nobilis).
